(19) United States
(12) Patent Application Publication
(10) Pub. No.: US 2026/0232505 A1
(43) Pub. Date: Aug. 13, 2026

(54) LIFTING ASSISTANCE VEST DEVICE

(71) Applicant: Keith Bookard, Blythewood, SC (US)

(72) Inventor: Keith Bookard, Blythewood, SC (US)

(21) Appl. No.: 19/053,099

(22) Filed: Feb. 13, 2025

(51) Int. Cl. A61G 5/14; A41D 1/04; A41D 13/12

(52) U.S. Cl. CPC A61G 5/14; A41D 1/04; A41D 13/1245

(57) ABSTRACT

A lifting assistance vest device includes a vest that can be worn on a torso of a user. A plurality of first straps and a plurality of second straps is each coupled to the vest to secure the vest around the torso of the user. A lifting belt extends around the vest such that a gripping section of the lifting belt can be gripped by a caregiver such that the caregiver can lift the user into a standing position. A pair of handles is each coupled to the vest and each handle of the pair of handles can be gripped by the caregiver such that the caregiver can lift the user into a standing position. The pair of handles are positioned on opposing sides of the vest with respect to each other such that each of the pair of handles can be gripped by a respective hand of the user.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to vest devices and more particularly pertains to a new vest device for assisting a caregiver with lifting a user into a standing position. The device includes a vest that can be worn on a torso of a user and a lifting belt that extends around the vest which can be gripped by a caregiver when the caregiver is standing behind the user to lift the user into a standing position. The device includes a pair of handles each coupled to opposing sides of the vest such that each of the pair of handles can be gripped when the caregiver is standing in front of the user to lift the user into a standing position.

### (2) Description of Related Art Including Information Disclosed Under 37 CFR 1.97 and 1.98

The prior art relates to vest devices including: an electrically insulated vest device with a grab handle strap; a variety of vest devices that each at least includes a vest and a pair of handles attached to opposing sides of the vest which can be gripped by an individual that is accompanying a user of the vest; a lifting garment device that includes a vest that is wearable on a paralyzed user and a plurality of handholds attached to the vest which can be gripped by a caregiver to lift the paralyzed user; an assistance garment that includes a vest and a hand engagement strap attached to the vest to secure a caregiver's hand to the vest to assist a user of the vest. In no instance does the prior art disclose a lifting assistance vest device that includes a vest that has a lifting belt extending around the vest that can be gripped by a caregiver that is standing behind a user wearing the vest to lift the user into a standing position and a pair of handles attached to opposite sides of the vest that can be gripped by the caregiver when the caregiver is standing in front of the user to lift the user into the standing position.

### (h) BRIEF SUMMARY OF THE INVENTION

An embodiment of the disclosure meets the needs presented above by generally comprising a vest that can be worn on a torso of a user. A plurality of first straps and a plurality of second straps is each coupled to the vest to secure the vest around the torso of the user. A lifting belt extends around the vest such that a gripping section of the lifting belt can be gripped by a caregiver such that the caregiver can lift the user into a standing position. A pair of handles is each coupled to the vest and each handle of the pair of handles can be gripped by the caregiver such that the caregiver can lift the user into a standing position. The pair of handles are positioned on opposing sides of the vest with respect to each other such that each of the pair of handles can be gripped by a respective hand of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a lifting assistance vest device according to an embodiment of the disclosure.

FIG. 2 is a back view of an embodiment of the disclosure.

FIG. 3 is a right side view of an embodiment of the disclosure.

FIG. 4 is a perspective in-use view of an embodiment of the disclosure.

### (J) DETAILED DESCRIPTION OF THE INVENTION

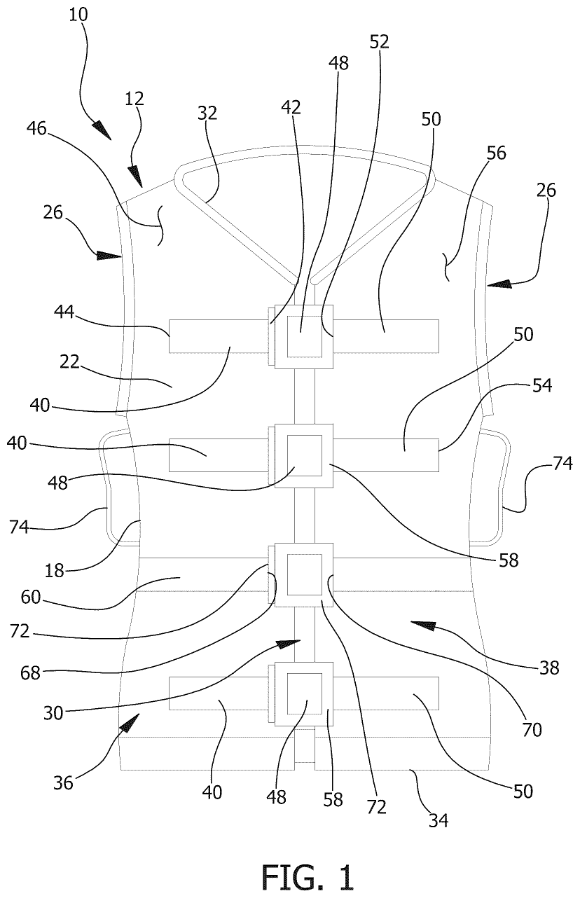

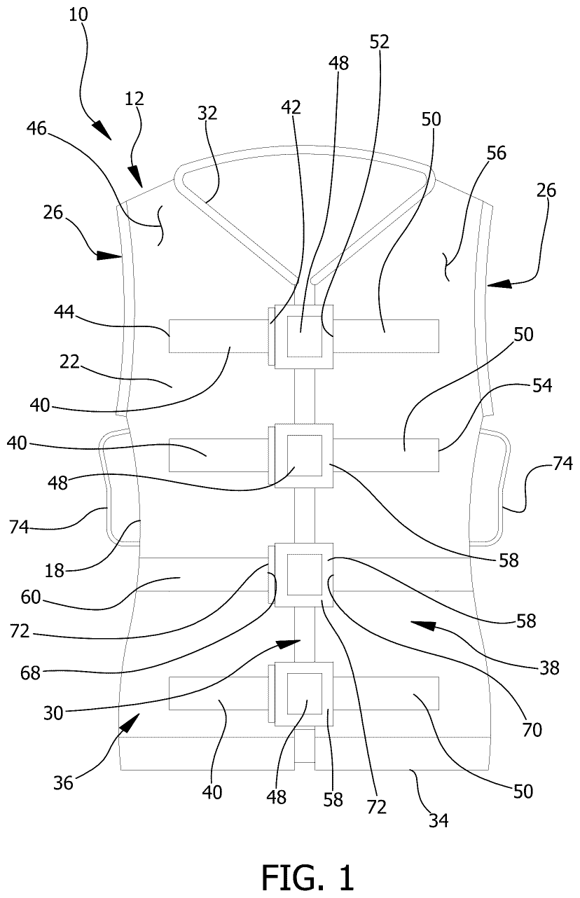

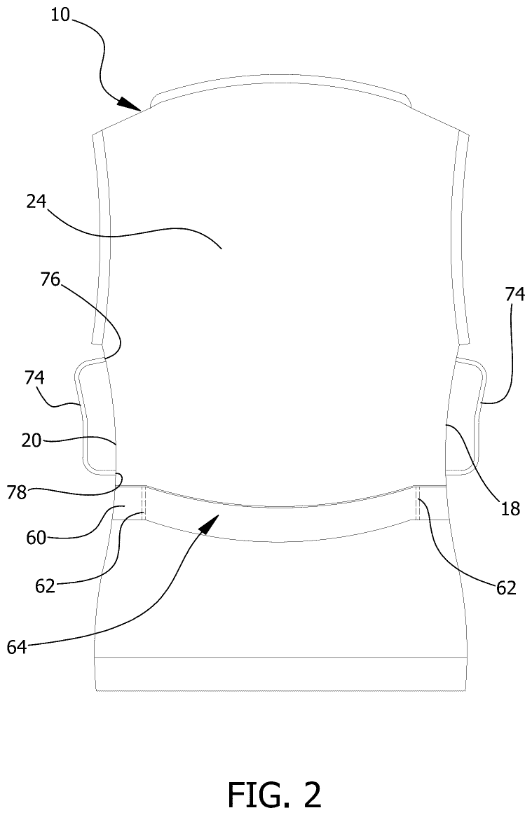

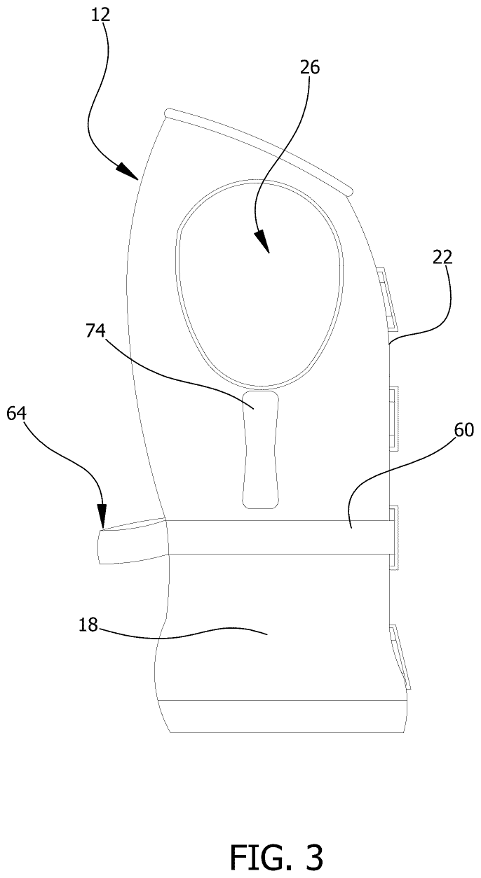

With reference now to the drawings, and in particular to FIGS. 1 through 4 thereof, a new vest device embodying the principles and concepts of an embodiment of the disclosure and generally designated by the reference numeral 10 will be described.

As best illustrated in FIGS. 1 through 4, the lifting assistance vest device 10 generally comprises a vest 12 which can be worn on a torso 14 of a user 16. The vest 12 has first lateral side 18 and a second lateral side 20 and a front side 22 and a back side 24; the vest 12 has a pair of arm holes 26 each extending through a respective one of the first lateral side 18 and the second lateral side 20 to accommodate a respective arm 28 of the user 16 when the user 16 wears the vest 12. The front side 22 has a cut 30 extending between a neck 32 of the vest 12 and a waist 34 of the vest 12 thereby defining a first half 36 of the front side 22 and a second half 38 of the front side 22. Furthermore, the cut 30 can be opened to extend the front side 22 around the torso 14 of the user 16 when the vest 12 is being positioned on the user 16. The user 16 may be a physically limited user, such as an individual that has suffered a stroke for example, or other individual that is not capable of standing on their own without assistance.

A plurality of first straps 40 is each coupled to the vest 12 and each first strap 40 of the plurality of first straps 40 is positioned on the first half 36 of the front half of the vest 12. Each first strap 40 of the plurality of first straps 40 is oriented to extend along a line extending between the first lateral side 18 of the vest 12 and the cut 30 in the front side 22. The plurality of first straps 40 is spaced apart from each other and is distributed between the neck 32 and the waist 34 of the vest 12. Additionally, each first strap 40 of the plurality of first straps 40 has a free end 42 and each first strap 40 of the plurality of first straps 40 extends beyond the cut 30 such that the free end 42 of each first strap 40 is spaced from the cut 30. Furthermore, each first strap 40 of the plurality of first straps 40 has a coupled end 44 which is coupled to an exterior surface 46 of the first half 36 of the front side 22 of the vest 12. A plurality of first couplers 48 is each movably coupled to the free end 42 of a respective first strap 40 of the plurality of first straps 40.

A plurality of second straps 50 is each coupled to the vest 12 and each second strap 50 of the plurality of second straps 50 is positioned on the second half 38 of the front half of the vest 12. Each second strap 50 of the plurality of second straps 50 is releasably matable to a respective first strap 40 of the plurality of first straps 40 to secure the vest 12 around the torso 14 of the user 16. Each second strap 50 of the plurality of second straps 50 is oriented to extend along a line extending between the second lateral side 20 of the vest 12 and the cut 30 in the front side 22. Additionally, the plurality of second straps 50 is spaced apart from each other and is distributed between the neck 32 and the waist 34 of the vest 12 and each second strap 50 of the plurality of second straps 50 has a free end 52.

Each second strap 50 of the plurality of second straps 50 extends beyond the cut 30 such that the free end 52 of each second strap 50 of the plurality of second straps 50 is spaced from the cut 30. Furthermore, the free end 52 of each second strap 50 of the plurality of second straps 50 is aligned with the free end 42 of a respective first strap 40 of the plurality of first straps 40. Each second strap 50 of the plurality of second straps 50 has a coupled end 54 which is coupled to an exterior surface 56 of the second half 38 of the front side 22 of the vest 12. A plurality of second couplers 58 is each movably coupled to the free end 52 of a respective second strap 50 of the plurality of second straps 50. The second coupler 58 on a respective second strap 50 of the plurality of second straps 50 is releasably matable to the first coupler 48 which is disposed on the free end 42 of the first strap 40 that is aligned with the respective second strap 50. Each of the first straps 40 can be shortened or lengthened in the respective first coupler 48 and each of the second straps 50 can be shortened or lengthened in the respective second coupler 58 to adjust the fit of the vest 12 on the user 16. Each first coupler 48 may comprise a male buckle of any conventional design, for example, and each second coupler 58 may comprise a female buckle of any conventional design, for example. Alternatively, each first coupler 48 and each second coupler 58 may comprise a complementary portion of a hook and loop fastener, for example, or other type of multiple use, mechanical coupler.

Each

A lifting belt 60 extends around the vest 12 and the lifting belt 60 has a pair of connection points 62 which are each coupled to the vest 12 such that a gripping section 64 of the lifting belt 60 is defined which extends between the pair of connection points 62. A caregiver 66 can grip the gripping section 64 when the user 16 is wearing the vest 12 such that the caregiver 66 can lift the user 16 into a standing position. Furthermore, the gripping section 64 extends along the back side 24 of the vest 12 such that the caregiver 66 can grip the gripping section 64 when the caregiver 66 is standing behind the user 16. The lifting belt 60 is releasably matable to itself to secure the vest 12 around the torso 14 of the user 16.

The lifting belt 60 has a first end 68 and a second end 70 and the lifting belt 60 is located between a respective pair of the plurality of first straps 40 and the plurality of second straps 50. Additionally, the lifting belt 60 extends beyond the cut 30 such that the first end 68 is spaced from the second end 70. Each connection point 62 of the pair of connection points 62 is located on the back side 24 of the vest 12 and each connection point 62 of the pair of connection points 62 is spaced from a respective one of the first lateral side 18 and the second lateral side 20 of the vest 12. A pair of lifting couplers 72 is provided; a respective gripping coupler 72 of the pair of lifting couplers 72 is movably coupled to the first end 68 of the lifting belt 60 and a respective lifting coupler 72 of the pair of lifting couplers 72 is coupled to the second end 70 of the lifting belt 60. Furthermore, the pair of lifting couplers 72 is releasably matable to each other and the pair of lifting couplers 72 may comprise a buckle, a hook and loop fastener or other type of multiple use fastener.

A pair of handles 74 is each coupled to the vest 12 and each handle 74 of the pair of handles 74 can be gripped by the caregiver 66 when the user 16 is wearing the vest 12 such that the caregiver 66 can lift the user 16 into a standing position. Each handle 74 of the pair of handles 74 is positioned on a respective one of the first lateral side 18 and the second lateral side 20 of the vest 12 such that each handle 74 of the pair of handles 74 can be gripped by the caregiver 66 when the caregiver 66 is standing in front of the user 16. Each handle 74 of the pair of handles 74 has a primary end 76 which is coupled to the vest 12 and each handle of the pair of handles 74 has a secondary end 78 which is coupled to the vest 12. Additionally, each handle of the pair of handles 74 is positioned between a respective arm hole 26 of the pair of arm holes 26 and the waist 34 of the vest 12 such that the caregiver 66 can lift the user 16 from each side of the user thereby enhancing stability of the user 16 when the caregiver 66 is lifting the user 16 into the standing position. Furthermore, each handle 74 of the pair of handles 74 is oriented to extend along a line which extends between the respective arm hole 26 and the waist 34 such that each handle 74 of the pair of handles 74 can be gripped by a respective hand 80 of the caregiver 66 when respective hand 80 of the caregiver 66 is in a neutral gripping position.

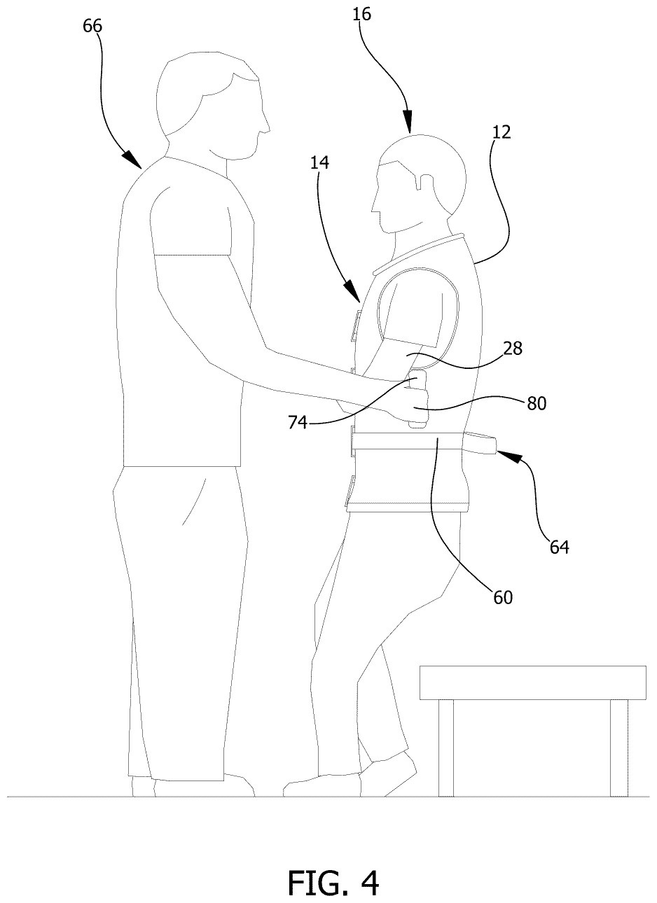

In use, the vest 12 is worn on the torso 14 of the user 16 and the caregiver 66 grips each of the handles 74 to lift the user 16 into a standing position from a seated position when the caregiver 66 is standing in front of the user 16. As is shown in FIG. 4, the caregiver 66 can assist the user 16 with standing up from a chair, for example, or other type of sitting furniture by gripping each of the handles 74 and lifting the user 16 in the standing position. Furthermore, the handles 74 enable the caregiver 66 to avoid having to lift the user 16 by the user's arms 28, which can potentially lead to a shoulder injury for the user 16. The caregiver 66 can grip the gripping section 64 of the lifting belt 60 when the caregiver 66 is standing behind the user 16. Furthermore, the caregiver 66 can grip the gripping section 64 to stabilize the user 16 when the user 16 is standing or to lift the user 16 into the standing position when the caregiver 66 is standing behind the user 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A lifting assistance vest device for assisting a caregiver with lifting a user into a standing position, said device comprising:
a vest being configured to be worn on a torso of the user;
a plurality of first straps, each first strap of said plurality of first straps being coupled to said vest;
a plurality of second straps, each second strap of said plurality of second straps being coupled to said vest, each second strap of said plurality of second straps being releasably matable to a respective first strap of said plurality of first straps wherein said plurality of first straps and said plurality of second straps are configured to secure said vest around the torso of the user;
a lifting belt extending around said vest, said lifting belt having a pair of connection points, each connection point of said pair of connection points being coupled to said vest such that a gripping section of said lifting belt is defined which extends between said pair of connection points wherein said gripping section is configured to be gripped by the caregiver when the user is wearing said vest such that the caregiver can lift the user into the standing position;
a pair of handles, each handle of said pair of handles being coupled to said vest wherein each handle of said pair of handles is configured to be gripped by the caregiver when the user is wearing said vest such that the caregiver can lift the user into the standing position, said pair of handles being positioned on opposing sides of said vest with respect to each other wherein each handle of said pair of handles is configured to be gripped by a respective hand of the user;
wherein said vest has a first lateral side and a second lateral side;
wherein said vest has a pair of arm holes each extending through a respective one of said first lateral side and said second lateral side wherein each arm hole of said pair of arm holes is configured to accommodate a respective arm of the user when the user wears said vest;
wherein each handle of said pair of handles has a primary end being coupled to said vest adjacent to a bottom of a respective one of said arm holes;
wherein each handle of said pair of handles has a secondary end being coupled to said vest; and
wherein each handle of said pair of handles is positioned between a respective arm hole of said pair of arm holes and said lifting belt wherein said pair of handles is configured to have the caregiver lift the user from each side of the user to enhance stability of the user when the caregiver is lifting the user into the standing position.

2. The lifting assistance vest device according to claim 1, wherein:
said vest has first lateral side and a second lateral side and a front side and a back side;
said front side has a cut extending between a neck of said vest and a waist of said vest thereby defining a first half of said front side and a second half of said front side wherein said cut is configured to be opened to extend said front side around the torso of the user while said vest is being positioned on the user;
each first strap of said plurality of first straps is positioned on said first half of said front half of said vest;
each first strap of said plurality of first straps has a free end; and
each first strap of said plurality of first straps has a coupled end being coupled to an exterior surface of said first half of said front side of said vest.

3. The lifting assistance vest device according to claim 2, wherein
each first strap of said plurality of first straps is oriented to extend along a line extending between said first lateral side of said vest and said cut in said front side;
said plurality of first straps is spaced apart from each other and is distributed between said neck and said waist of said vest.

4. The lifting assistance vest device according to claim 2, wherein:
each second strap of said plurality of second straps is positioned on said second half of said front half of said vest; and
each second strap of said plurality of second straps has a coupled end being coupled to an exterior surface of said second half of said front side of said vest.

5. The lifting assistance vest device according to claim 4, wherein:
each second strap of said plurality of second straps is oriented to extend along a line extending between said second lateral side of said vest and said cut in said front side;
said plurality of second straps is spaced apart from each other and is distributed between said neck and said waist of said vest;
each second strap of said plurality of second straps has a free end; and
said free end of each second strap of said plurality of second straps is aligned with said free end of a respective first strap of said plurality of first straps.

6. The lifting assistance vest device according to claim 5, wherein:
said lifting assistance vest device includes a plurality of first couplers;
each first coupler of said plurality of first couplers is coupled to said free end of a respective first strap of said plurality of first straps;
said device includes a plurality of second couplers;
each second coupler of said plurality of second couplers is coupled to said free end of a respective second strap of said plurality of second straps; and
said second coupler on the respective second strap of said plurality of second straps is releasably matable to said first coupler which is disposed on said free end of said first strap that is aligned with said respective second strap.

7. The lifting assistance vest device according to claim 1, wherein:
said vest has first lateral side and a second lateral side and a front side and a back side; and
said gripping section of said lifting belt extends along said back side of said vest wherein said gripping section is configured to be gripped by the caregiver when the caregiver is standing behind the user.

8. The lifting assistance vest device according to claim 1, wherein:
said vest has a front side;
said front side of said vest has a cut extending between a neck of said vest and a waist of said vest thereby defining a first half of said front side and a second half of said front side wherein said cut is configured to be opened to extend said front side around the torso of the user when said vest is being positioned on the user;
said lifting belt has a first end and a second end;
said lifting belt is located between a respective pair of said plurality of first straps and said plurality of second straps.

9. The lifting assistance vest device according to claim 1, wherein:
said vest has a back side; and
each connection point of said pair of connection points is located on said back side of said vest.

10. The lifting assistance vest device according to claim 1, wherein:
said vest has a first lateral side and a second lateral side; and
each connection point of said pair of connection points is spaced from a respective one of said first lateral side and said second lateral side of said vest.

11. The lifting assistance vest device according to claim 1, wherein:
said lifting belt has a first end and a second end;
said lifting assistance vest device includes said a plurality of first couplers;
said lifting assistance vest device includes a plurality of second couplers;
said lifting assistance vest device includes a pair of lifting couplers;
a first gripping coupler of said pair of lifting couplers is coupled to said first end of said lifting belt;
a second gripping coupler of said pair of lifting couplers is coupled to said second end of said lifting belt; and
said pair of lifting couplers is releasably matable to each other.

12. The device according to claim 1, wherein:
said vest has a first lateral side and a second lateral side; and
each handle of said pair of handles is positioned on a respective one of said first lateral side and said second lateral side of said vest wherein each handle of said pair of handles is configured to be gripped by the caregiver when the caregiver is standing in front of the user.

13. (canceled)

14. The lifting assistance vest device according to claim 1, wherein each handle of said pair of handles is oriented to extend along a line which extends between said respective arm hole and a waist of said vest wherein each handle of said pair of handles is configured to be gripped by a respective hand of the caregiver when the respective hand of the caregiver is in a neutral gripping position.

15. A lifting assistance vest device for assisting a caregiver with lifting a user into a standing position, said device comprising:
a vest being configured to be worn on a torso of the user, said vest having first lateral side and a second lateral side and a front side and a back side, said vest having a pair of arm holes each extending through a respective one of said first lateral side and said second lateral side wherein each arm hole of said pair of arm holes is configured to accommodate a respective arm of the user when the user wears said vest, said front side having a cut extending between a neck of said vest and a waist of said vest thereby defining a first half of said front side and a second half of said front side wherein said cut is configured to be opened to extend said front side around the torso of the user when said vest is being positioned on the user;
a plurality of first straps, each first strap of said plurality of first straps being coupled to said vest, each first strap of said plurality of first straps being positioned on said first half of said front half of said vest, each first strap of said plurality of first straps being oriented to extend along a line extending between said first lateral side of said vest and said cut in said front side, said plurality of first straps being spaced apart from each other and being distributed between said neck and said waist of said vest, each first strap of said plurality of first straps having a free end, each first strap of said plurality of first straps having a coupled end being coupled to an exterior surface of said first half of said front side of said vest;
a plurality of first couplers, each first coupler of said plurality of first couplers being coupled to said free end of a respective first strap of said plurality of first straps;
a plurality of second straps, each second strap of said plurality of second straps being coupled to said vest, each second strap of said plurality of second straps being positioned on said second half of said front half of said vest, each second strap of said plurality of second straps being releasably matable to the respective first strap of said plurality of first straps wherein said plurality of first straps and said plurality of second straps are configured to secure said vest around the torso of the user, each second strap of said plurality of second straps being oriented to extend along a line extending between said second lateral side of said vest and said cut in said front side, said plurality of second straps being spaced apart from each other and being distributed between said neck and said waist of said vest, each second strap of said plurality of second straps having a free end, said free end of each second strap of said plurality of second straps being aligned with said free end of the respective first strap of said plurality of first straps, each second strap of said plurality of second straps having a coupled end being coupled to an exterior surface of said second half of said front side of said vest;
a plurality of second couplers, each second coupler of said plurality of second couplers being coupled to said free end of a respective second strap of said plurality of second straps, said second coupler on the respective second strap of said plurality of second straps being releasably matable to said first coupler which is disposed on said free end of said first strap that is aligned with said respective second strap;
a lifting belt extending around said vest, said lifting belt having a pair of connection points, each connection point of said pair of connection points being coupled to said vest such that a gripping section of said lifting belt is defined which extends between said pair of connection points wherein said gripping section is configured to be gripped by a caregiver when the user is wearing said vest such that the caregiver can lift the user into the standing position, said gripping section extending along said back side of said vest wherein said gripping section is configured to be gripped by the caregiver when the caregiver is standing behind the user, said lifting belt being releasably matable to itself wherein said lifting belt is configured to secure said vest around the torso of the user, said lifting belt having a first end and a second end, said lifting belt being located between a respective pair of said plurality of first straps and said plurality of second straps, each connection point of said pair of connection points being located on said back side of said vest, each connection point of said pair of connection points being spaced from a respective one of said first lateral side and said second lateral side of said vest;
a pair of lifting couplers, a first gripping coupler of said pair of lifting couplers being coupled to said first end of said lifting belt, a second gripping coupler of said pair of lifting couplers being coupled to said second end of said lifting belt, said pair of lifting couplers being releasably matable to each other; and
a pair of handles, each handle of said pair of handles being coupled to said vest wherein each handle of said pair of handles is configured to be gripped by the caregiver when the user is wearing said vest such that the caregiver can lift the user into a standing position, each handle of said pair of handles being positioned on the respective one of said first lateral side and said second lateral side of said vest wherein each handle of said pair of handles is configured to be gripped by the caregiver when the caregiver is standing in front of the user, each handle of said pair of handles having a primary end being coupled to said vest adjacent to a bottom of a respective one of said arm holes, each handle of said pair of handles having a secondary end being coupled to said vest, each handle of said pair of handles being positioned between a respective arm hole of said pair of arm holes and said lifting belt wherein said pair of handles is configured to have the caregiver lift the user from each side of the user to enhance stability of the user when the caregiver is lifting the user into the standing position, each handle of said pair of handles being oriented to extend along a line which extends between said respective arm hole and said waist wherein each handle of said pair of handles is configured to be gripped by a respective hand of the caregiver when the respective hand of the caregiver is in a neutral gripping position.
